(19) United States
(12) Patent Application Publication
(10) Pub. No.: US 2026/0107196 A1
(43) Pub. Date: Apr. 16, 2026

(54) COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Xin YOU, Dongguan (CN); Xue LIN, Dongguan (CN)

(73) Assignee: GUANGDONG OPPO MOBILE TELECOMMUNICATIONS CORP., LTD., Dongguan (CN)

(21) Appl. No.: 19/406,667

(22) Filed: Dec. 2, 2025

Related U.S. Application Data
(63) Continuation of application No. PCT/CN2023/102200, filed on Jun. 25, 2023.

(51) Int. Cl. H04W 36/00; H04W 36/08

(52) U.S. Cl. CPC H04W 36/0077; H04W 36/0072; H04W 36/08

(57) ABSTRACT

A terminal device is provided. The terminal device includes a memory and a processor, where the memory is configured to store a computer program, and the processor is configured to execute the computer program stored in the memory to cause the terminal device to perform an operation of: initiating an early synchronization process, where a transmitting power corresponding to the early synchronization process is determined based on first information.

### CROSS-REFERENCE TO RELATED APPLICATIONS

This application is a continuation of International Application No. PCT/CN2023/102200, filed on Jun. 25, 2023, the disclosure of which is hereby incorporated by reference in its entirety.

### TECHNICAL FIELD

This application relates to the communications field, and more specifically, to a communication method, a terminal device, and a network device.

### RELATED ART

A communications system supports a handover process of a user terminal in a connected state. In some scenarios, to ensure continuity of communication and quality of a service, a communications system may perform a handover process. In the handover process, the communications system may transfer a communication link between a user terminal and an original cell to a new cell, thereby reducing an interrupt latency caused by handover, and improving communication quality.

### SUMMARY

Embodiments of this application provide a communication method, a terminal device, and a network device, such that communication quality can be improved.

An embodiment of this application provides a communication method, including:
initiating, by a terminal device, an early synchronization process, where a transmitting power corresponding to the early synchronization process is determined based on first information.

An embodiment of this application provides a terminal device, including a memory and a processor, where the memory is configured to store a computer program, and the processor is configured to execute the computer program stored in the memory to cause the terminal device to perform an operation of:
initiating an early synchronization process, where a transmitting power corresponding to the early synchronization process is determined based on first information.

An embodiment of this application provides a network device, including a memory and a processor, where the memory is configured to store a computer program, and the processor is configured to execute the computer program stored in the memory to cause the network device to perform an operation of
transmitting first information, where the first information is used to determine a transmitting power corresponding to an early synchronization process of a terminal device.

### BRIEF DESCRIPTION OF DRAWINGS

FIG. 1 is a schematic diagram of an application scenario according to an embodiment of this application.

FIG. 2 is a schematic diagram of an inter-base station cell handover procedure according to an embodiment of this application.

FIG. 3 is a schematic flowchart of a communication method according to an embodiment of this application.

FIG. 4 is a schematic flowchart of a communication method according to another embodiment of this application.

FIG. 5 is a schematic flowchart of a communication method according to another embodiment of this application.

FIG. 6 is a schematic flowchart of a communication method according to another embodiment of this application.

FIG. 7 is a schematic flowchart of a communication method according to another embodiment of this application.

FIG. 8 is a schematic flowchart of a communication method according to another embodiment of this application.

FIG. 9 is a schematic flowchart of a communication method according to an embodiment of this application.

FIG. 10 is a schematic flowchart of a communication method according to another embodiment of this application.

FIG. 11 is a schematic block diagram of a terminal device according to an embodiment of this application.

FIG. 12 is a schematic block diagram of a terminal device according to another embodiment of this application.

FIG. 13 is a schematic block diagram of a network device according to an embodiment of this application.

FIG. 14 is a schematic block diagram of a network device according to another embodiment of this application.

FIG. 15 is a schematic flowchart of a communication method according to an application scenario of this application.

FIG. 16 is a schematic flowchart of a communication method according to another application scenario of this application.

FIG. 17 is a schematic block diagram of a communications device according to an embodiment of this application.

FIG. 18 is a schematic block diagram of a chip according to an embodiment of this application.

FIG. 19 is a schematic block diagram of a communications system according to an embodiment of this application.

### DESCRIPTION OF EMBODIMENTS

The following describes the technical solutions in embodiments of this application with reference to the accompanying drawings in embodiments of this application.

The technical solutions in embodiments of this application may be applied to various communications systems, for example, a global system for mobile communications (GSM) system, a code-division multiple access (CDMA) system, a wideband code-division multiple access (WCDMA) system, a general packet radio service (GPRS) system, a long term evolution (LTE) system, an advanced long term evolution (LTE-A) system, a new radio (NR) system, an evolved NR system, an LTE-based access to unlicensed spectrum (LTE-U) system, an NR-based access to unlicensed spectrum (NR-U) system, a non-terrestrial networks (NTN) system, a universal mobile telecommunication system (UMTS), a wireless local area network (WLAN) system, wireless fidelity (WiFi), a fifth-generation (5G) communications system, or another communications system.

Generally, a quantity of connections supported by a conventional communications system is limited, and is easy to implement. However, with the development of communication technologies, a mobile communications system not only supports conventional communication, but also supports, for example, device to device (D2D) communication, machine to machine (M2M) communication, machine type communication (MTC), vehicle to vehicle (V2V) communication, or vehicle to everything (V2X) communication, or the like. Embodiments of this application may also be applied to these communications systems.

In an implementation, a communications system in embodiments of this application may be applied to a carrier aggregation (CA) scenario, a dual connectivity (DC) scenario, or a standalone (SA) networking scenario.

In an implementation, a communications system in embodiments of this application may be applied to an unlicensed spectrum, and the unlicensed spectrum may also be considered as a shared spectrum. Alternatively, a communications system in embodiments of this application may be applied to a licensed spectrum, and the licensed spectrum may also be considered as a non-shared spectrum.

Embodiments of this application are described with reference to a network device and a terminal device. The terminal device may also be referred to as a user equipment (UE), an access terminal, a subscriber unit, a subscriber station, a mobile site, a mobile station, a remote station, a remote terminal, a mobile device, a user terminal, a terminal, a wireless communications device, a user agent, a user apparatus, or the like.

The terminal device may be a station (ST) in a WLAN, a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communications system such as an NR network, a terminal device in a future evolved public land mobile network (PLMN), or the like.

In embodiments of this application, the terminal device may be deployed on land, including being deployed indoors or outdoors, or being handheld, wearable, or vehicle-mounted. The terminal device may also be deployed on water (for example, on a ship), or may be deployed in the air (for example, on an airplane, an air balloon, or a satellite).

In embodiments of this application, the terminal device may be a mobile phone, a tablet computer (Pad), a computer with a wireless transceiver function, a virtual reality (VR) terminal device, an augmented reality (AR) terminal device, a wireless terminal device in industrial control, a wireless terminal device in self driving, a wireless terminal device in remote medical, a wireless terminal device in a smart grid, a wireless terminal device in transportation safety, a wireless terminal device in a smart city, a wireless terminal device in a smart home, or the like.

By way of example rather than limitation, in embodiments of this application, the terminal device may alternatively be a wearable device. The wearable device may also be referred to as a smart wearable device, and is a general term for wearable devices, such as glasses, gloves, watches, clothes, and shoes, that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, the smart wearable device includes a full-featured and large-sized device that can implement some or all of functions without relying on a smart phone, for example, a smart watch or smart glasses, and a device that focuses on only a specific type of application function and is required to cooperate with another device such as a smart phone for use, for example, various smart bracelets and smart jewelries for physical sign monitoring.

In embodiments of this application, the network device may be a device configured to communicate with a mobile device. The network device may be an access point (AP) in a WLAN, a base transceiver station (BTS) in GSM or CDMA, a NodeB (NodeB, NB) in WCDMA, an evolved Node B (Evolutional Node B, eNB or eNodeB) in LTE, a relay station or an access point, a vehicle-mounted device, a wearable device, a network device (gNB) in an NR network, a network device in a future evolved PLMN network, a network device in an NTN network, or the like.

By way of example rather than limitation, in embodiments of this application, the network device may have a mobility characteristic. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may alternatively be a base station disposed in a location such as land or water.

In embodiments of this application, the network device may provide a service for a cell. The terminal device communicates with the network device by using a transmission resource (for example, a frequency domain resource or a spectrum resource) used by the cell. The cell may be a cell corresponding to the network device (for example, a base station). The cell may belong to a macro station or may belong to a base station corresponding to a small cell. The small cell herein may include a metro cell, a micro cell, a pico cell, a femto cell, or the like. These small cells have characteristics of a small coverage and a low transmit power, and are applicable to providing a high-rate data transmission service.

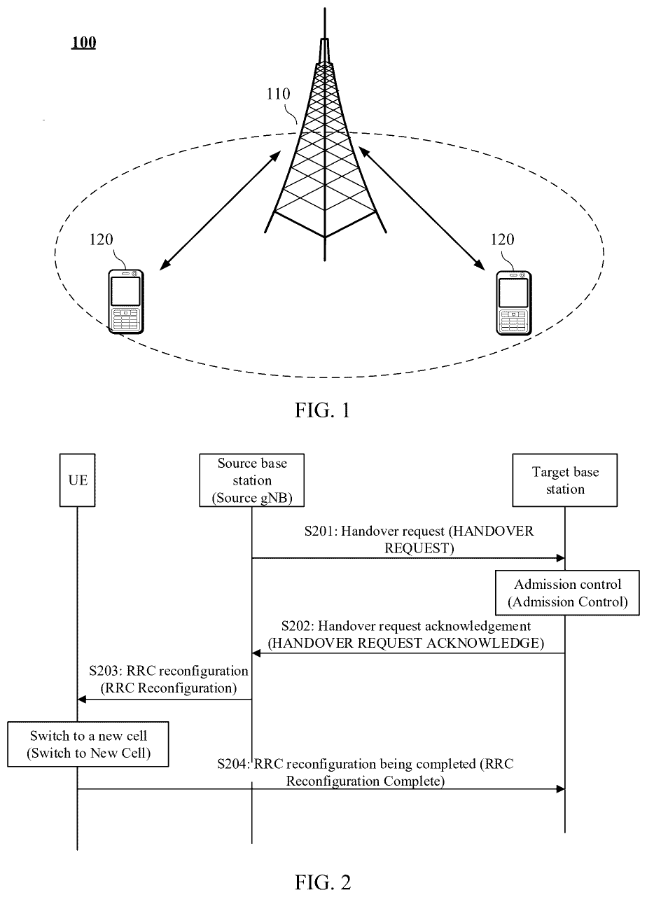

FIG. 1 exemplarily shows a communications system 100. The communications system includes one network device 110 and two terminal devices 120. In an implementation, the communications system 100 may include a plurality of network devices 110, and different quantities of terminal devices 120 may be located in coverage of the network devices 110, which is not limited in embodiments of this application.

In an implementation, the communications system 100 may further include another network entity such as a mobility management entity (MME) or an access and mobility management function (AMF), which is not limited in embodiments of this application.

The network device may further include an access network device and a core network device, that is, the wireless communications system further includes a plurality of core networks configured to communicate with the access network device. The access network device may be an evolved Node B (evolutional node B, which may be an eNB or an e-NodeB for short), a macro base station, a micro base station (also referred to as a “small base station”), a pico base station, an access point (AP), a transmission point (TP), or a new generation Node B (gNodeB), or the like in a long-term evolution (LTE) system, a next-generation (mobile communications system) (next radio, NR) system, or an authorized auxiliary access long-term evolution (LAA-LTE) system.

It should be understood that in embodiments of this application, a device having a communication function in a network/system may be referred to as a communications device. The communications system shown in FIG. 1 is used as an example. The communications device may include a network device and a terminal device that have a communication function. The network device and the terminal device may be specific devices in embodiments of this application. Details are not described herein again. The communications device may further include another device in the communications system, for example, another network entity such as a network controller or a mobility management entity. This is not limited in embodiments of this application.

It should be understood that the terms “system” and “network” in this specification may often be used interchangeably in this specification. In this specification, the term “and/or” is merely an association relationship that describes associated objects, and indicates that three relationships may exist. For example, A and/or B may represent three cases: only A exists, both A and B exist, and only B exists. In addition, the character “/” in this specification generally indicates an “or” relationship between the associated objects.

It should be understood that, “indicate” mentioned in embodiments of this application may refer to a direct indication, or may refer to an indirect indication, or may mean that there is an association relationship. For example, if A indicates B, it may mean that A directly indicates B, for example, B may be obtained by using A. Alternatively, it may mean that A indirectly indicates B, for example, A indicates C, and B may be obtained by using C. Alternatively, it may mean that there is an association relationship between A and B.

In the description of embodiments of this application, the term “corresponding” may mean that there is a direct or indirect correspondence between two elements, or that there is an association relationship between two elements, or that there is a relationship of “indicating” and “being indicated”, “configuring” and “being configured”, or the like.

To facilitate understanding of the technical solutions in embodiments of this application, the following describes related technologies in embodiments of this application. The following related technologies, as optional solutions, may be randomly combined with the technical solutions in embodiments of this application, all of which fall within the protection scope of embodiments of this application.

### 1. Conventional Handover Procedure

Similar to an LTE system, an NR system supports a handover process of a UE in a connected state. For example, when a user who is using a network service moves from one cell to another cell, or due to reasons such as adjustment of a load of a wireless transmission service, activation operation and maintenance, and a device fault, the system is required to transfer a communication link between the user and an original cell to a new cell, that is, execute a handover process, to ensure continuity of communication and quality of the service.

For example, FIG. 2 is a schematic diagram of an inter-base station cell handover procedure, which may include the following procedure S201 to S204.

S201: A source base station (Source gNB) triggers handover based on a layer 3 (L3) measurement result reported by a terminal, and transmits a handover request to a target base station (target cell) by using an Xn interface.

S202: The target base station receives the handover request (admission control) from the source base station, provides a radio resource control (RRC) configuration of the target cell, and feeds back the configuration to the source base station as part of a handover request acknowledgement.

S203: The source base station transmits an RRC reconfiguration to a UE, to instruct the UE to initiate a handover procedure, and to indicate RRC configuration information used to access the target cell.

S204: The UE accesses the target cell, for example, switches to a new cell (Switch to New Cell), and transmits an RRC reconfiguration complete message to the target cell.

### 2. Layer 1 or Layer 2 Triggered Mobility (L1/L2 Triggered Mobility, LTM)

To further reduce interrupt latency caused by handover, an LTM triggered mobility (L1/L2 triggered mobility) method may be used. LTM is a handover procedure triggered by underlying signalling. In order to pre-configure a plurality of candidate cells for a UE, the UE performs layer 1 (L1) measurement on these candidate cells and reports measurement results to a network side. A network determines a target cell based on the measurement report from the UE side and transmits a handover command to the UE, to instruct the UE to perform handover.

In an LTM process, to reduce latency caused by an uplink synchronization process, the network may instruct the UE to initiate a random access process (also referred to as a RACH process) to the candidate cell when being connected with a serving cell. In this way, when receiving a preamble transmitted by the UE and being selected as the target cell for handover, the candidate cell may indicate timing advance (TA) in the handover command to the UE. In this way, it is unnecessary for the UE to perform a random access process after receiving the handover command, thereby reducing handover interrupt latency.

The UE may transmit the random access process to the candidate cell, in response to trigger from a physical downlink control channel (PDCCH) order (order) of the network. Different from a conventional random access process, the random access process initiated by the UE to the LTM candidate cell does not require reception of a random access response (RAR). If the candidate cell fails to receive the preamble and calculate TA due to insufficient power after the UE transmits the preamble, the network is required to trigger the UE again to transmit the preamble. According to the communication method in embodiments of this application, it may be ensured that a UE maintains power ramping in a subsequent preamble transmission.

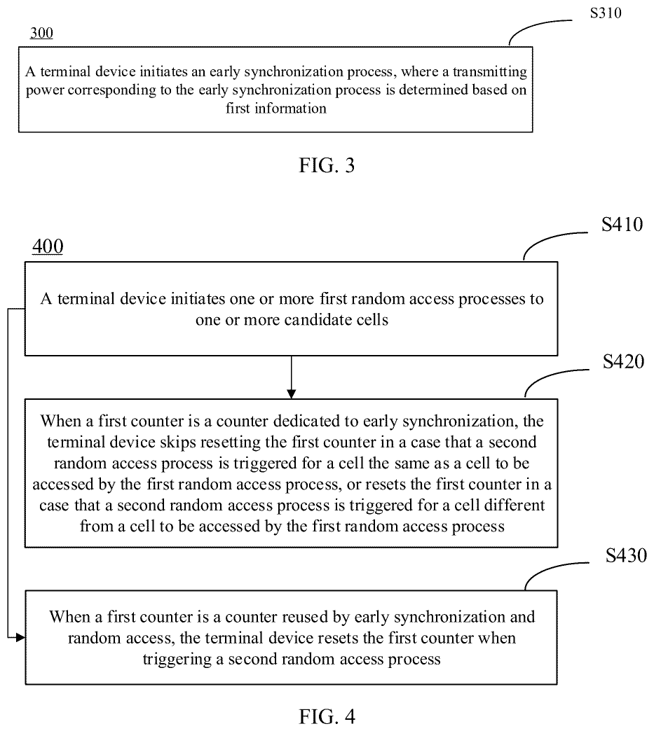

FIG. 3 is a schematic flowchart of a communication method according to an embodiment of this application. Optionally, the method 300 may be applied to the system shown in FIG. 1, but is not limited thereto. The method includes at least S310.

S310: A terminal device initiates an early synchronization process, where a transmitting power corresponding to the early synchronization process is determined based on first information.

In embodiments of this application, the terminal device may initiate an early synchronization (early sync) process (also referred to as an early synchronization procedure) to one or more candidate cells. The early synchronization process may be performed before a handover process. For example, in a layer 1 or layer 2 triggered mobility (LTM) process, the candidate cell may be an LTM candidate cell. The terminal device may initiate the early synchronization process to the LTM candidate cell when being connected with a serving cell. When an LTM candidate cell is selected as a target cell for handover, a network may indicate TA to the terminal device in a handover command. In this way, it is unnecessary for the terminal device to perform a random access process (also referred to as a random access procedure) after receiving the handover command, thereby reducing an interrupt latency caused by handover, and improving communication quality.

In embodiments of this application, a transmitting power (also referred to as a transmit power) used by the terminal device in the early synchronization process for transmitting information may be determined based on the first information. The first information may be information locally maintained by the terminal device, or may be information transmitted by a network device to the terminal device. The first information may include a plurality of types of information. For example, the first information may include a value of a counter, may also include a power value, an offset value, or a ramping value indicated by the network device, and may further include a transmission type of the random access process, for example, a new transmission or a retransmission. Specifically, one or more of these types of information may be flexibly selected based on a requirement of an actual application scenario.

According to embodiments of this application, communication quality can be improved by reasonably determining a transmitting power corresponding to an early synchronization process. For example, whether the transmitting power corresponding to the early synchronization process requires ramping may be determined based on first information, such that ramping of the transmitting power is controlled in time, thereby improving a success rate of information transmission, and further improving communication quality. For example, in an early synchronization scenario, a UE may control power ramping of preamble transmission, thereby ensuring continuity of communication and quality of a service.

FIG. 4 is a schematic flowchart of a communication method according to another embodiment of this application. The method 400 may include one or more features of the communication method in the foregoing embodiment. In an implementation, the terminal device initiating the early synchronization process in S310 includes: S410: initiating, by the terminal device, one or more first random access processes to one or more candidate cells.

In an implementation, a transmitting power of second information in the one or more first random access processes is determined based on the first information.

In an implementation, the second information includes a message 1, a message A, or a preamble in the first random access process.

In embodiments of this application, the first random access process may be a random access process used for early synchronization. The second information in the first random access process may be a message 1 of four-step random access, or may be a message A of two-step random access, or may be a preamble in the message 1 or the message A.

For example, in an LTM process, the terminal device may initiate one or more random access processes to an LTM candidate cell when being connected with a serving cell. In the random access process, a UE may transmit a preamble to the LTM candidate cell. The random access process initiated by the terminal device to the LTM candidate cell may not require reception of an RAR. The terminal device may determine, based on the first information, whether the transmitting power is required to ramp after each random access process is performed. For example, if the candidate cell fails to receive the preamble and calculate TA due to insufficient power after the UE transmits the preamble, the UE may control, based on the first information, the transmitting power to ramp, and then retransmit the preamble with the ramped transmitting power, thereby improving a reception success rate of the preamble by the candidate cell.

In an implementation, the first information includes a power ramp quantity in the early synchronization process. For example, the power ramp quantity in the first information may be obtained based on a transmission quantity of the message 1, the message A, or the preamble in the early synchronization process. For example, each time the terminal device transmits the preamble to one candidate cell, the power ramp quantity corresponding to the candidate cell is increased by 1. When the power ramp quantity is increased, the transmitting power of the terminal device may be increased accordingly. The power ramp quantity may correspond to a specific power value, or may correspond to a power offset value. For example, the power ramp quantity being 2 corresponds to a power 2, and the power ramp quantity being 3 corresponds to a power 3, where the power 3 is greater than the power 2. For another example, the power ramp quantity being 2 corresponds to a power offset value 2, and the power ramp quantity being 3 corresponds to a power offset value 3, where the power offset value 3 is greater than the power offset value 2.

In an implementation, the first information includes a value of a first counter. The value of the counter is used to indicate the power ramp quantity in the early synchronization process. For example, the terminal device may locally maintain a counter used for early synchronization. The value of the counter may represent the power ramp quantity, an information transmission quantity, or the like in the early synchronization process. An initial value of the counter may be pre-configured or may be a default value. For example, the first random access process corresponds to the first counter. An initial value of the first counter is 0. Each time the preamble is transmitted in the first random access process, the value of the first counter is increased by 1. Alternatively, when the terminal device initializes the first random access process, the first counter may be set to 1; and in subsequent retransmissions, each time the preamble is transmitted, the counter is increased by 1. In embodiments of this application, the value of the counter being 0, 1, or the like is merely an example but not a limitation; and specific numerical values, such as the initial value and the ramping value, of the counter may be set according to an actual scenario.

In an implementation, the first counter is a counter reused by early synchronization and random access.

In an implementation, the first counter is a counter dedicated to early synchronization. In embodiments of this application, when the terminal device triggers a new random access process, the counter reused by early synchronization and random access may be reset, that is, the counter may start to count from the initial value again; and it may be unnecessary to reset the counter dedicated to early synchronization.

In an implementation, the first counter is a preamble power ramping counter. The preamble power ramping counter may be the counter reused by early synchronization and random access, for example, a PREAMBLE_POWER_RAMPING_COUNTER in random access.

In an implementation, the first counter is a preamble power ramping counter for LTM. For another example, the preamble power ramping counter for LTM may be a counter dedicated to early synchronization in an LTM process, for example, a PREAMBLE_POWER_RAMPING_COUNTER_LTM.

In an implementation, as shown in FIG. 4, the method 400 further includes:
S420: when a first counter is a counter dedicated to early synchronization, skipping resetting the first counter in a case that a second random access process is triggered for a cell the same as a cell to be accessed by the first random access process, or resetting, by the terminal device, the first counter in a case that a second random access process is triggered for a cell different from a cell to be accessed by the first random access process.

In embodiments of this application, the second random access process may be a random access process newly triggered after the first random access process. The second random access process may be random access triggered by another event, for example, triggered by an SR, triggered by BFR, triggered by uplink and downlink data arrival, triggered by system information acquisition, or the like. Alternatively, the second random access process may be triggered by an early synchronization process, and may be initiated to a same candidate cell in the early synchronization process, where the early synchronization is used for initiating random access to another candidate cell.

For example, the value of the first counter is 3, which indicates that a power ramp quantity of a preamble transmitted by the UE to a candidate cell 1 is 3. If the UE transmits the preamble to the candidate cell 1 in the newly triggered second random access process, the UE skips resetting the first counter T1, and may initiate the second random access process to the candidate cell 1 by still using the value of the first counter T1. For another example, the value of the first counter is 3L , which indicates that the power ramp quantity of the preamble transmitted by the UE to the candidate cell 1 is 3. If the UE transmits the preamble to a candidate cell 2 in the newly triggered second random access process, the UE may reset the first counter T1, for example, reset T1 to 1, and initiate the second random access process to the candidate cell 2 by using a preset initial power.

In an implementation, as shown in FIG. 4, the method 400 further includes: S430: when a first counter is a counter reused by early synchronization and random access, resetting, by the terminal device, the first counter when triggering a second random access process. In embodiments of this application, if the first counter is used to represent not only a power ramp quantity of a preamble in the early synchronization process, but also a power ramp quantity of a preamble in a conventional random access process, the terminal device may reset the value of the first counter to the initial value when triggering a new second random access process. For example, the value of the first counter is 3, which indicates that a power ramp quantity of a preamble transmitted by the UE to the candidate cell 1 is 3. If the UE transmits the preamble to the candidate cell 1 in a newly triggered random access process, the UE resets the value of the first counter to an initial value such as 1 or 0.

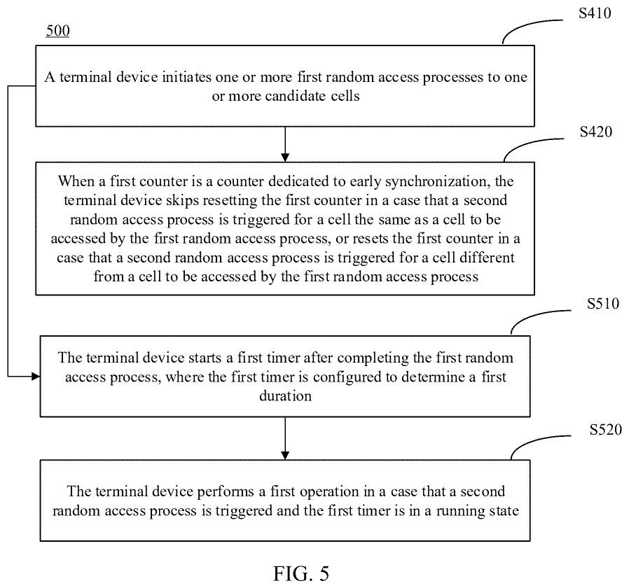

FIG. 5 is a schematic flowchart of a communication method according to another embodiment of this application. The method 500 may include one or more features of the communication method in the foregoing embodiments. In an implementation, as shown in FIG. 5, the method further includes: S510: starting, by the terminal device, a first timer after completing the first random access process, where the first timer is configured to determine a first duration. The first duration may be used to control a duration during which a first operation is allowed to be performed after the first random access process is completed. In an implementation, the first operation is used to temporarily store the value of the first counter.

The terminal device performing the first operation in S430 of the method includes: S520: performing, by the terminal device, the first operation in a case that the second random access process is triggered and the first timer is in a running state. For example, when the first timer is in the running state, that is, the second random access process is triggered within the first duration, the terminal device may perform the first operation, and temporarily store the value of the first counter. In a subsequently triggered second random access process, the transmitting power may be determined by using the value of the first counter. If the first timer stops running, that is, the first duration expires, the value of the first counter may be reset. When the second random access process is triggered again subsequently, a transmitting power is not determined by using an accumulated value of the first counter. Instead, the transmitting power may be determined by using a reset value of the first counter.

In an implementation, the first operation includes storing the value of the first counter into a temporary counter and/or assigning the value of the first counter to a first variable. For example, the UE stores a value of the first counter before initialization of a newly triggered random access process into a temporary counter, for example, a temporary power counter (temporary power counter). For another example, the UE assigns the value of the first counter before initialization of the newly triggered random access process to a new variable, for example, a temporary preamble power ramping counter (PREAMBLE_POWER_RAMPING_COUNTER_TEMPORARY).

In an implementation, a condition for performing the first operation includes at least one of the following:
a network device indicating that the first operation is to be performed;
the second random access process occurring after the first random access process; or
the second random access process occurring within a first duration after the first random access process is completed.

For example, if information received by the terminal device from the network device instructs to temporarily store a value of a reused counter, the terminal device may perform the first operation, that is, store the value of the first counter into the temporary counter and/or assign the value of the first counter to the first variable. For another example, after the first random access process is triggered or completed, the second random access process is triggered. In this case, the terminal may autonomously perform the first operation, or may perform the first operation based on the indication from the network device. For another example, if the second random access process is triggered within the first duration after the first random access process is completed, the first operation may be performed. If the second random access process is triggered beyond the first duration, the first operation may no longer be performed.

In an implementation, a stopping condition for the first timer includes: the second random access process being triggered. In embodiments of this application, if the first timer is in the running state when the second random access process is triggered, the first operation is performed, and the first timer may be stopped or reset.

In an implementation, the method further includes: performing, by the terminal device, the first operation before initializing the second random access process.

In embodiments of this application, if a counter is reused by early synchronization and random access, an original power ramp quantity may be obtained, and the value of the first counter may be stored temporarily and retrieved for use later when required.

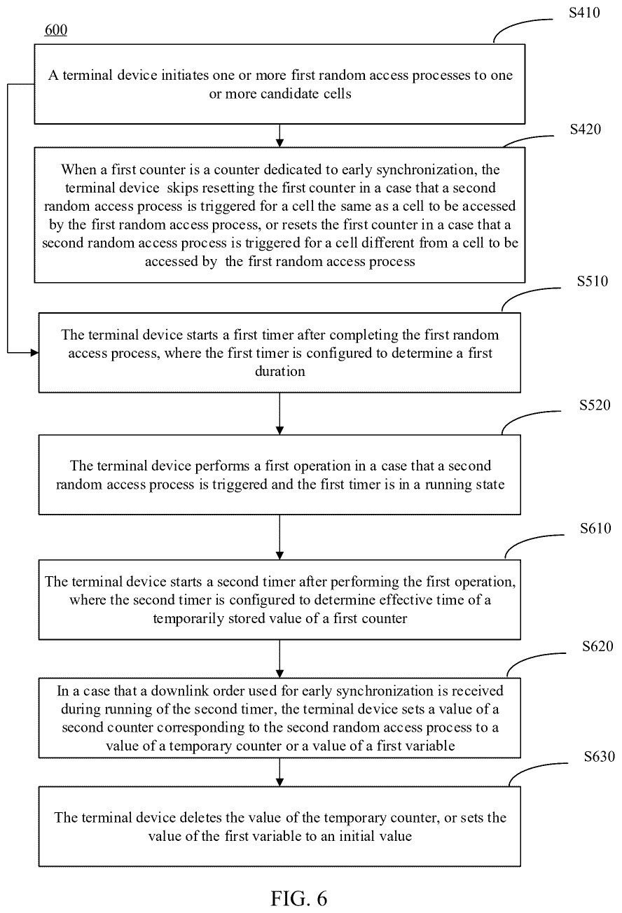

FIG. 6 is a schematic flowchart of a communication method according to another embodiment of this application. The method 600 may include one or more features of the communication method in the foregoing embodiments. In an implementation, the method further includes: S610: starting, by the terminal device, a second timer after performing the first operation, where the second timer is configured to determine effective time of a temporarily stored value of a first counter.

In an implementation, as shown in FIG. 6, the method further includes: S620: in a case that a downlink order used for early synchronization is received during running of the second timer, and that a candidate index in the downlink order is the same as a candidate cell index corresponding to the first random access process, setting, by the terminal device, a value of a second counter corresponding to the second random access process to a value of a temporary counter or a value of a first variable during initialization of the second random access process.

In some examples, the terminal device may maintain an independent counter for each candidate cell or each early synchronization process. For example, the terminal device stores a value (for example, 3) of a first counter for a first random access process of one candidate cell (for example, whose candidate cell index is C1) into the temporary counter and/or assigns the value to the first variable, and then starts the second timer. During running of the second timer, if the terminal device receives a downlink order for the candidate cell, for example, a downlink order whose candidate index is C1, a value of a second counter corresponding to a second random access process of the candidate cell C1 may be set to a temporarily stored counter value or variable value, for example, 3. In this case, a transmitting power used in this second random access process is determined based on the value 3 of the second counter. Compared with a solution in which the second random access process is performed by using an initial transmitting power after the counter is reset, the second random access process may be performed with a higher transmitting power determined based on the temporarily stored value according to the solution of this application, thereby being beneficial to improving a probability of successful reception of a preamble by the network device, for example, a candidate cell.

In an implementation, as shown in FIG. 6, the method further includes: S630: deleting, by the terminal device, the value of the temporary counter, or setting the value of the first variable to an initial value. For example, after performing the second random access process by using the value of the temporary counter or the value of the first variable, the terminal device may delete the value of the temporary counter, or set the value of the temporary counter to the initial value, for example, 0 or 1, or set the value of the first variable to the initial value, for example, 0 or 1. In this way, in a subsequently triggered random access process, a preamble may be transmitted by using an initial power.

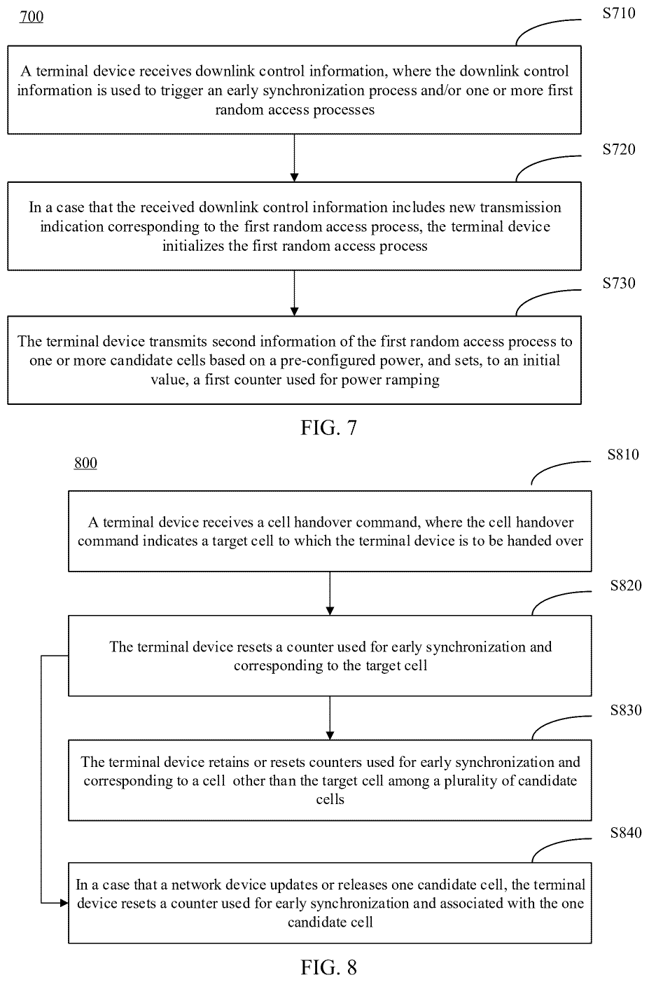

FIG. 7 is a schematic flowchart of a communication method according to another embodiment of this application. The method 700 may include one or more features of the communication method in the foregoing embodiments. In an implementation, the first information includes power control information, and the power control information is used to determine a transmitting power at which the terminal device transmits a message 1, a message A, or a preamble in a first random access process. For example, the network device transmits the power control information to the terminal device, to explicitly or implicitly indicate a transmitting power to be used by the terminal device for initiating the first random access process.

In an implementation, the power control information includes a power value, or the power control information includes at least one of an offset value or a ramping value that is used to adjust the transmitting power. For example, if the power control information includes a power value, the terminal device may adjust, to the power value, a transmitting power used for transmitting the preamble in a current first random access process. For another example, if the power control information includes an offset value of a transmitting power, the terminal device may adjust a transmitting power used for transmitting a preamble in the current first random access process to a value obtained by adding the offset value to or subtracting the offset value from a last transmitting power. For another example, if the power control information includes a ramping value of a transmitting power, the terminal device may adjust a transmitting power used for transmitting a preamble in the current first random access process to a value obtained by adding the ramping value to a last transmitting power.

In an implementation, the first information includes new transmission/retransmission indication information, and the new transmission/retransmission indication information is used to indicate a new transmission or a retransmission. In embodiments of this application, the new transmission/retransmission indication information may include one or more bits that are used to indicate a new transmission or a retransmission. For example, a value of a bit being 1 indicates a retransmission, and a value of the bit being 0 indicates a new transmission. For another example, a value of a bit being 0 indicates a retransmission, and a value of the bit being 1 indicates a new transmission.

For example, the new transmission/retransmission indication information transmitted by the network device to the terminal device may include new transmission indication or the initial transmission indication. In this case, the terminal device may transmit for the first time the message 1 or the message A in the random access process to one or more candidate cells, based on the new transmission indication or the initial transmission indication. The message 1 or the message A may include a preamble. In addition, the terminal device may set a value of a preamble power ramping counter corresponding to this random access process or a value of an LTM preamble power ramping counter to 1.

In an implementation, the new transmission/retransmission indication information is used to indicate a quantity of retransmissions. For example, if the quantity of retransmissions indicated by the new transmission/retransmission indication information is 2, it may indicate that 2 retransmissions are to be performed. After receiving the new transmission/retransmission indication information, the terminal device may continuously transmit a random access preamble twice. In addition, a transmitting power may be increased once, each time a transmission is performed. An increment of the transmitting power may be set according to a requirement of an actual application scenario.

In an implementation, the method further includes: S710: receiving, by the terminal device, downlink control information, where the downlink control information is used to trigger the early synchronization process and/or one or more first random access processes. For example, the downlink control information may include indication used for triggering the early synchronization process and/or the random access process. For another example, the downlink control information may implicitly instruct to trigger the early synchronization process and/or the random access process. In embodiments of this application, the foregoing power control information and/or new transmission/retransmission indication information may be indicated by the downlink control information, for example, a PDCCH order.

In an implementation, the downlink control information is used to indicate at least one of the following: a candidate cell index, power control information, new transmission/retransmission indication information, random access resource indication information, bandwidth part BWP indication information, or a transmission-reception point TRP index.

In embodiments of this application, the downlink control information may explicitly or implicitly indicate one or more pieces of the foregoing information. For example, the downlink control information may include a candidate cell index and power control information. After receiving the downlink control information, the terminal device may determine, based on the candidate cell index, a value of a first counter corresponding to a candidate cell that requires early synchronization and/or random access, and then determine, based on the value of the first counter, a power used for transmitting a random access preamble to the candidate cell. For another example, the downlink control information may include new transmission/retransmission indication information and random access resource indication information. If the new transmission/retransmission indication information includes new transmission indication, after a random access preamble is transmitted based on a resource corresponding to the random access resource indication information, increasing the value of the first counter or setting the value of the first counter to 1 may not be performed. If the new transmission/retransmission indication information includes retransmission indication, after a random access preamble is transmitted based on a resource corresponding to the random access resource indication information, the value of the first counter may be increased by 1 or another value.

In an implementation, the random access resource indication information includes at least one of the following: a random access preamble index, uplink indication, supplementary uplink indication, a synchronization signal/physical broadcast channel block (Synchronization Signal/PBCH Block, SSB) index, or a physical random access channel mask index.

In an implementation, the downlink control information includes a physical downlink control channel (PDCCH) order, and the PDCCH order is used to instruct the terminal device to initiate the early synchronization process to one or more candidate cells. For example, the PDCCH order instructs the terminal device to initiate a random access process to the one or more candidate cells.

In an implementation, as shown in FIG. 7, the operation of initiating, by the terminal device, the one or more first random access processes to the one or more candidate cells in step S410 includes:
S720: in a case that the received downlink control information includes new transmission indication corresponding to the first random access process, initializing, by the terminal device, the first random access process; and
S730: transmitting, by the terminal device, second information of the first random access process to one or more candidate cells based on a pre-configured power, and setting, by the terminal device, a value of a first counter used for power ramping to an initial value.

In embodiments of this application, the second information of the random access process may be a random access preamble, a message 1, a message A, or the like. For example, the network device transmits the PDCCH order to the terminal device. If new transmission/retransmission indication information in the PDCCH order includes new transmission indication or initial transmission indication, after receiving the PDCCH order, the terminal device may transmit the second information such as the message 1, the message A, or the preamble in the first random access process to a candidate cell that corresponds to a candidate cell index in the PDCCH order. In addition, when or after transmitting the second information for the first time, the terminal device may set the value of the first counter to an initial value, for example, 1.

In an implementation, the pre-configured power is a preamble received target power for the second information. A transmitting power that may be used by the terminal device for transmitting the second information for the first time may be a pre-configured preamble received target power.

In an implementation, the operation of initiating, by the terminal device, the one or more first random access processes to the one or more candidate cells in step S410 further includes: in a case that the received downlink control information includes retransmission indication or power ramping indication corresponding to the first random access process, retransmitting, by the terminal device, second information of the first random access process to the one or more candidate cells, and increasing, by the terminal device, a value of a first counter.

For example, after the preamble of the first random access process is transmitted for the first time, and if the new transmission/retransmission indication information in the PDCCH order received by the terminal device includes retransmission indication, or the power control information includes power ramping indication, the terminal device may retransmit, after receiving the PDCCH order, the second information such as the message 1, the message A, or the preamble in the first random access process to a candidate cell that corresponds to a candidate cell index in the PDCCH order. In addition, when or after retransmitting the second information for one time or a plurality of times, the terminal device may increase the value of the first counter, for example, increase the value of the first counter by 1.

In an implementation, the operation of initiating, by the terminal device, the one or more first random access processes to the one or more candidate cells in step S410 further includes: in a case that the downlink control information received after the second information of the first random access process is newly transmitted or retransmitted includes new transmission indication corresponding to the first random access process, skipping, by the terminal device, increasing the value of the first counter, and determining, by the terminal device, a transmitting power of current second information based on the current value of the first counter.

For example, after the preamble of the first random access process is transmitted for one time or a plurality of times, the new transmission/retransmission indication information in the PDCCH order received by the terminal device includes new transmission indication. The plurality of transmissions may include one new transmission and at least one retransmission. After receiving the PDCCH order, the terminal device may transmit the second information such as the message 1, the message A, or the preamble in the first random access process to a candidate cell that corresponds to a candidate cell index in the PDCCH order.

If the PDCCH order received by the terminal device instructs to initiate early synchronization to a same candidate cell to which a new transmission or a retransmission is performed previously, for example, a candidate cell 1, the terminal device may not increase the value of the first counter when or after transmitting the second information. For example, if a value of the first counter that corresponds to a last transmission is 3, the terminal device may transmit, after receiving new transmission indication again, the second information to the candidate cell 1 by using a transmitting power that corresponds to an original value of the first counter, for example, 3.

If the PDCCH order received by the terminal device instructs to initiate early synchronization to another candidate cell different from a candidate cell to which a new transmission or a retransmission is performed previously, for example, a candidate cell 2 or a serving cell, the terminal device may initialize the first counter when or after transmitting the second information. For example, if a value of the first counter that corresponds to a last transmission is 3, the terminal device may reset the value of the first counter to 1 after receiving new transmission indication again.

In an implementation, the operation of initiating, by the terminal device, the one or more first random access processes to the one or more candidate cells in step S410 includes: continuously transmitting, by the terminal device, second information of the first random access process to the one or more candidate cells for a plurality of times based on a pre-configured preamble transmission quantity, where each time the second information is transmitted, the transmitting power ramps once.

In embodiments of this application, the terminal device may autonomously trigger the early synchronization process. In this case, the early synchronization process may be triggered without depending on control information of the network device. For example, a pre-configured preamble transmission quantity of a candidate cell is 3. The terminal device may continuously transmit the second information such as the message 1, the message A, or the preamble in the first random access process to the candidate cell for three times. After the second information is transmitted for the first time, a value of a first counter corresponding to the candidate cell may be set to 1. After the second information is transmitted for the second time, the value of the first counter corresponding to the candidate cell may be set to 2. After the second information is transmitted for the third time, the value of the first counter corresponding to the candidate cell may be set to 3. Different values of the first counter correspond to different transmitting powers. For example, a larger value of the first counter corresponds to a larger transmitting power.

FIG. 8 is a schematic flowchart of a communication method according to another embodiment of this application. The method 800 may include one or more features of the communication method in the foregoing embodiments. In an implementation, the method further includes:

S810: receiving, by a terminal device, a cell handover command, where the cell handover command indicates a target cell to which the terminal device is to be handed over; and

S820: resetting, by the terminal device, a counter used for early synchronization and corresponding to the target cell.

In embodiments of this application, after the early synchronization process, one or more candidate cells may receive an index of random access of the terminal device. A network device selects, as the target cell for handover, a candidate cell that can receive the index of the terminal device, and transmits the cell handover command to the terminal device. The cell handover command may include the target cell for handover selected by the network device for the terminal device. After receiving the cell handover command, the terminal device may perform a handover process to the target cell, and may reset a value of the counter used for early synchronization and corresponding to the target cell, for example, at least one of the first counter, or the second counter described above.

In an implementation, as shown in FIG. 8, the method further includes: S830, retaining or resetting, by the terminal device, counters used for early synchronization and corresponding to a cell other than the target cell among a plurality of candidate cells. In embodiments of this application, one of the N candidate cells is a target cell, and values of counters used for early synchronization and corresponding to the remaining N−1 cells may be retained, or may be reset. For example, after receiving the cell handover command, the terminal device determines that the candidate cell 1 is the target cell, and may reset the timer T1 corresponding to the candidate cell 1 to 1. For the remaining candidate cells, a value of a timer T2 corresponding to the candidate cell 2 is retained at 2, and a value of a timer T3 corresponding to a candidate cell 3 is retained at 4. Subsequently, a preamble is retransmitted to the candidate cell 2 based on a transmitting power corresponding to the value 2 of T2, and a preamble is retransmitted to the candidate cell 3 based on a transmitting power corresponding to the value 4 of T3.

In an implementation, as shown in FIG. 8, the method further includes: S840: in a case that a network device updates or releases one candidate cell, resetting, by the terminal device, a counter used for early synchronization and associated with the one candidate cell. For example, in a case that the network device instructs the terminal device to update the candidate cell 2, a value of the counter T2 corresponding to the candidate cell 2 may be reset to 1. For another example, in a case that the network device instructs the terminal device to release the candidate cell 3, a value of the counter T3 corresponding to the candidate cell 3 may be reset to 1.

In an implementation, the method further includes: receiving, by the terminal device, candidate cell pre-configuration information. This step may be performed before S710. The terminal device may receive the candidate cell pre-configuration information from the network device.

In an implementation, the candidate cell pre-configuration information includes at least one of the following:
a configuration of at least one candidate cell;
a resource and/or a configuration for performing uplink synchronization to the at least one candidate cell;
a measurement configuration and/or reporting configuration of the at least one candidate cell;
an L1 measurement configuration and/or an L3 measurement configuration; or
an L1 measurement reporting configuration and/or an L3 measurement reporting configuration.

In an implementation, the method further includes: performing, by the terminal device, measurement and reporting on a candidate cell based on the candidate cell pre-configuration information, where the measurement includes L1 measurement and/or L3 measurement. The reporting of the measurement is carried in an RRC message, uplink control information (UCI), or a medium access control (MAC) control element (CE). This step may be performed before S710. After receiving the candidate cell pre-configuration information from the network device, the terminal device may perform measurement on the candidate cell based on the candidate cell pre-configuration information. For example, if the candidate cell pre-configuration information includes configurations of a plurality of candidate cells, the L1 measurement configuration, and the L1 measurement reporting configuration, the terminal device may perform L1 measurement on the plurality of candidate cells based on the L1 measurement configuration, and report measurement results based on the L1 measurement reporting configuration. The network device may transmit downlink control information based on the measurement result, to trigger an early synchronization process to the candidate cell. For another example, if the candidate cell pre-configuration information includes configurations of a plurality of candidate cells, resources for performing uplink synchronization to the plurality of candidate cells, and the L3 measurement configuration, L3 measurement may be performed on the plurality of candidate cells based on these resources, to obtain measurement results. The terminal device may trigger the early synchronization process to the candidate cell based on the measurement result.

In an implementation, the early synchronization process is triggered by the terminal device based on indication from the network device. For example, the network device may instruct, by using the downlink control information, for example, the PDCCH order, the terminal device to initiate the early synchronization process to the one or more candidate cells.

In an implementation, the early synchronization process is autonomously triggered by the terminal device. For example, the terminal device may determine, based on the measurement result, to perform the early synchronization process to the one or more candidate cells.

In an implementation, the early synchronization process is triggered based on a measurement result of the terminal device, and the measurement result is determined based on a measurement event and/or a pre-configured threshold.

For example, the terminal device may trigger the early synchronization process based on the measurement event. The terminal device may trigger the early synchronization process when detecting a measurement event. There may be multiple types of measurement events, for example, the following events:
Event A2: Serving becomes worse than an absolute threshold (Event A2: Serving becomes worse than absolute threshold);
Event A3: Neighbour's amount of offset becomes better than that of a primary cell (PCell)/primary secondary cell (PSCell) (Event A3: Neighbour becomes amount of offset better than PCell/PSCell);
Event A4: Neighbour becomes better than an absolute threshold (Event A4: Neighbour becomes better than absolute threshold); and
Event A5: PCell/PCell becomes worse than an absolute threshold 1, and neighbour/secondary cell (SCell) becomes better than another absolute threshold 2 (Event A5: PCell/PSCell becomes worse than absolute threshold 1 AND Neighbour/SCell becomes better than another absolute threshold 2).

For another example, the terminal device may determine, based on a pre-configured threshold, whether to trigger the early synchronization process. Specifically, for example, if measured strength of a signal is greater than a specified threshold, the early synchronization process may be triggered. If measured strength of another signal is less than the specified threshold, the early synchronization process may be triggered.

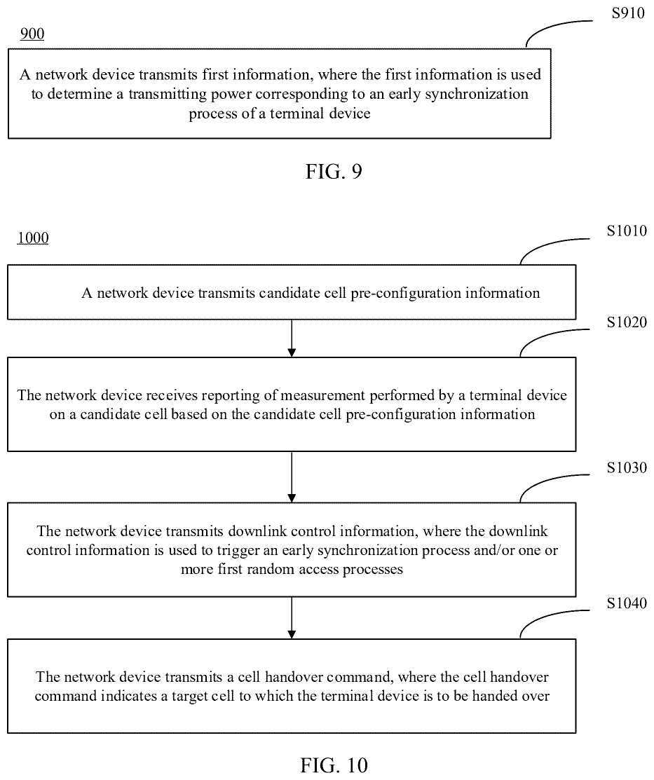

FIG. 9 is a schematic flowchart of a communication method according to an embodiment of this application. Optionally, the method 900 may be applied to the system shown in FIG. 1, but is not limited thereto. The method includes at least S910.

S910: A network device transmits first information, where the first information is used to determine a transmitting power corresponding to an early synchronization process of a terminal device.

In an implementation, the first information includes power control information, and the power control information is used to determine a transmitting power at which the terminal device transmits a message 1, a message A, or a preamble in a first random access process.

In an implementation, the power control information includes a power value, or the power control information includes at least one of an offset value or a ramping value that is used to adjust the transmitting power.

In an implementation, the first information includes new transmission/retransmission indication information, and the new transmission/retransmission indication information is used to indicate a new transmission or a retransmission.

In an implementation, the new transmission/retransmission indication information is used to indicate a quantity of retransmissions.

FIG. 10 is a schematic flowchart of a communication method according to another embodiment of this application. The method 1000 may include one or more features of the communication method in the foregoing embodiments. In an implementation, as shown in FIG. 10, the method further includes:

S1010: transmitting, by a network device, candidate cell pre-configuration information. This step may be performed before S910.

In an implementation, the candidate cell pre-configuration information includes at least one of the following:
a configuration of at least one candidate cell;
a resource and/or a configuration for performing uplink synchronization to the at least one candidate cell;
a measurement configuration and/or reporting configuration of the at least one candidate cell;
an L1 measurement configuration and/or an L3 measurement configuration; or an L1 measurement reporting configuration and/or an L3 measurement reporting configuration.

In an implementation, as shown in FIG. 10, the method further includes:

S1020: receiving, by the network device, reporting of measurement performed by a terminal device on a candidate cell based on the candidate cell pre-configuration information, where the measurement includes L1 measurement and/or L3 measurement, and the reporting of the measurement is carried in an RRC message or UCI or a MAC CE. This step may be performed before S910.

In an implementation, the process of transmitting, by the network device, the first information includes:
S1030: transmitting, by the network device, downlink control information, where the downlink control information is used to trigger an early synchronization process and/or one or more first random access processes. In embodiments of this application, the first information may be indicated by the downlink control information. For example, power control information, new transmission/retransmission indication information, or the like indicated by the downlink control information may be the first information.

In an implementation, the downlink control information is used to indicate at least one of the following: a candidate cell index, power control information, new transmission/retransmission indication information, random access resource indication information, BWP indication information, or a TRP index.

In an implementation, the random access resource indication information includes at least one of the following: a random access preamble index, uplink indication, supplementary uplink indication, an SSB index, or a physical random access channel mask index.

In an implementation, the downlink control information includes a PDCCH order, and the PDCCH order is used to instruct the terminal device to initiate the early synchronization process to one or more candidate cells.

In an implementation, as shown in FIG. 10, the method further includes:
S1040: transmitting, by the network device, a cell handover command, where the cell handover command indicates a target cell to which the terminal device is to be handed over.

For specific examples in which the network device performs the methods 900 and 1000 in embodiments, one may refer to the related descriptions of the network device such as a base station in the foregoing methods 300 to 800. For brevity, details are not described herein again.

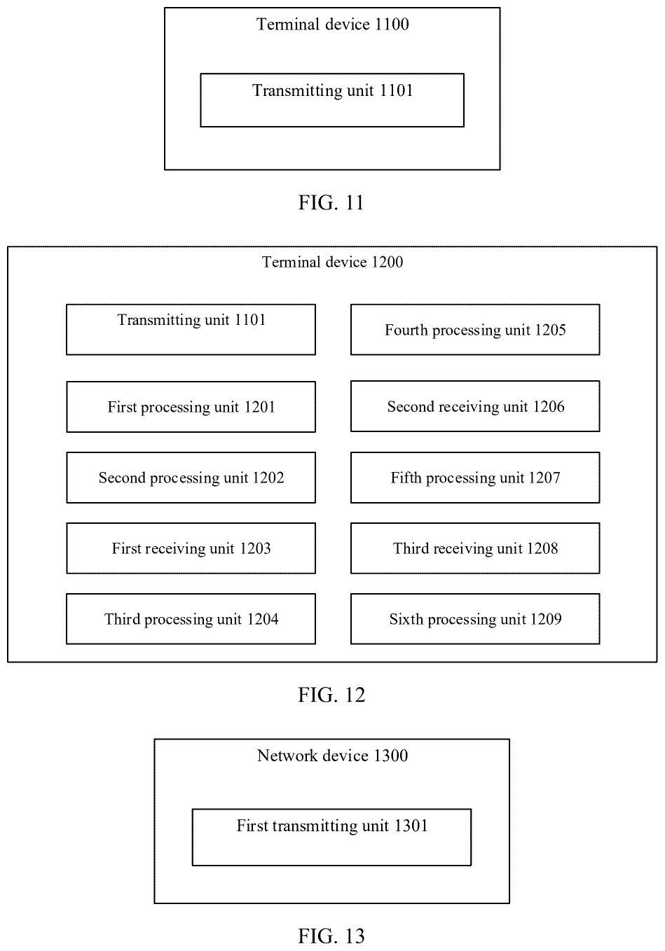

FIG. 11 is a schematic block diagram of a terminal device according to an embodiment of this application. The terminal device 1100 may include:
a transmitting unit 1101, configured to initiate an early synchronization process, where a transmitting power corresponding to the early synchronization process is determined based on first information.

In an implementation, the transmitting unit is further configured to initiate one or more first random access processes to one or more candidate cells.

A transmitting power of second information in the one or more first random access processes is determined based on the first information.

In an implementation, the second information includes a message 1, a message A, or a preamble in the first random access process.

In an implementation, the first information includes a power ramp quantity in the early synchronization process.

In an implementation, the first information includes a value of a first counter. The value of the counter is used to indicate the power ramp quantity in the early synchronization process.

In an implementation, the first counter is a counter reused by early synchronization and random access, or a counter dedicated to early synchronization.

In an implementation, the first counter is a preamble power ramping counter, or a preamble power ramping counter for LTM.

FIG. 12 is a schematic block diagram of a terminal device according to another embodiment of this application. The terminal device 1200 may include one or more features of the terminal device in the foregoing embodiments. In an implementation, the terminal device 1200 further includes:
a first processing unit 1201, configured to: when the first counter is a counter dedicated to early synchronization, skip resetting the first counter in a case that a second random access process is triggered for a cell the same as a cell to be accessed by using a first random access process, or reset the first counter in a case that a second random access process is triggered for a cell different from a cell to be accessed by a first random access process.

In an implementation, as shown in FIG. 12, the terminal device 1200 further includes: a second processing unit 1202, configured to: when the first counter is a counter reused by early synchronization and random access, reset the first counter when triggering a second random access process.

In an implementation, the second processing unit 1202 is further configured to perform a first operation before initializing the second random access process, where the first operation is used to temporarily store the value of the first counter.

In an implementation, the first operation includes storing the value of the first counter into a temporary counter and/or assigning the value of the first counter to a first variable.

In an implementation, a condition for performing the first operation includes at least one of the following:
a network device indicating that the first operation is to be performed;
the second random access process occurring after the first random access process; or
the second random access process occurring within a first duration after the first random access process is completed.

In an implementation, the second processing unit 1202 is further configured to:
start the first timer after completing the first random access process, where the first timer is configured to determine the first duration; and
perform the first operation in a case that the second random access process is triggered and the first timer is in a running state.

In an implementation, a stopping condition for the first timer includes: the second random access process being triggered.

In an implementation, the second processing unit 1202 is further configured to start a second timer after performing the first operation, where the second timer is configured to determine effective time of the temporarily stored value of the first counter.

In an implementation, the second processing unit 1202 is further configured to: in a case that a downlink order used for early synchronization is received during running of the second timer, and that a candidate index in the downlink order is the same as a candidate cell index corresponding to the first random access process, set a value of a second counter corresponding to the second random access process to a value of a temporary counter or a value of a first variable during initialization of the second random access process.

In an implementation, the second processing unit 1202 is further configured to delete the value of the temporary counter, or set the value of the first variable to an initial value.

In an implementation, the first information includes power control information, and the power control information is used to determine a transmitting power at which the terminal device transmits a message 1, a message A, or a preamble in a first random access process.

In an implementation, the power control information includes a power value, or the power control information includes at least one of an offset value or a ramping value that is used to adjust the transmitting power.

In an implementation, the first information includes new transmission/retransmission indication information, and the new transmission/retransmission indication information is used to indicate a new transmission or a retransmission.

In an implementation, the new transmission/retransmission indication information is used to indicate a quantity of retransmissions.

In an implementation, as shown in FIG. 12, the terminal device 1200 further includes:
a first receiving unit 1203, configured to receive downlink control information, where the downlink control information is used to trigger an early synchronization process and/or one or more first random access processes.

In an implementation, the downlink control information is used to indicate at least one of the following: a candidate cell index, power control information, new transmission/retransmission indication information, random access resource indication information, bandwidth part BWP indication information, or a transmission-reception point TRP index.

In an implementation, the random access resource indication information includes at least one of the following: a random access preamble index, uplink indication, supplementary uplink indication, an SSB index, or a physical random access channel mask index.

In an implementation, the downlink control information includes a PDCCH order, and the PDCCH order is used to instruct the terminal device to initiate the early synchronization process to one or more candidate cells.

In an implementation, as shown in FIG. 12, the terminal device 1200 further includes:
a third processing unit 1204, configured to: in a case that the received downlink control information includes new transmission indication corresponding to the first random access process, initialize the first random access process, and set a value of a first counter used for power ramping to an initial value;
wherein the transmitting unit is further configured to transmit second information of the first random access process to one or more candidate cells based on a pre-configured power.

In an implementation, the pre-configured power is a preamble received target power for the second information.

In an implementation, as shown in FIG. 12, the terminal device 1200 further includes: a fourth processing unit 1205, configured to: in a case that the downlink control information received by the terminal device includes retransmission indication or power ramping indication corresponding to the first random access process, increase a value of a first counter;
wherein the transmitting unit is further configured to retransmit second information of the first random access process to one or more candidate cells.

In an implementation, the fourth processing unit is further configured to: in a case that the downlink control information received after the second information of the first random access process is newly transmitted or retransmitted includes new transmission indication corresponding to the first random access process, skip increasing the value of the first counter, and determine a transmitting power of current second information based on the current value of the first counter.

In an implementation, the transmitting unit is further configured to continuously transmit second information of a first random access process to one or more candidate cells for a plurality of times based on a pre-configured preamble transmission quantity, where each time the second information is transmitted, the transmitting power ramps once.

In an implementation, as shown in FIG. 12, the terminal device 1200 further includes:
a second receiving unit 1206, configured to receive a cell handover command, where the cell handover command indicates a target cell to which the terminal device is to be handed over; and
a fifth processing unit 1207, configured to reset a counter used for early synchronization and corresponding to the target cell.

In an implementation, the fifth processing unit is further configured to retain or reset counters used for early synchronization and corresponding to a cell other than the target cell among a plurality of candidate cells.

In an implementation, the fifth processing unit is further configured to: in a case that a network device updates or releases one candidate cell, reset a counter used for early synchronization and associated with the one candidate cell.

In an implementation, the terminal device 1200 further includes:
a third receiving unit 1208, configured to receive candidate cell pre-configuration information, where the candidate cell pre-configuration information includes at least one of the following:
a configuration of at least one candidate cell;
a resource and/or a configuration for performing uplink synchronization to the at least one candidate cell;
a measurement configuration and/or reporting configuration of the at least one candidate cell;
an L1 measurement configuration and/or an L3 measurement configuration; or an L1 measurement reporting configuration and/or an L3 measurement reporting configuration.

In an implementation, as shown in FIG. 12, the terminal device 1200 further includes:
a sixth processing unit 1209, configured to perform measurement and reporting on the candidate cell based on the candidate cell pre-configuration information, where the measurement includes L1 measurement and/or L3 measurement, and the reporting of the measurement is carried in an RRC message or UCI or a MAC CE.

In an implementation, the early synchronization process is triggered by the terminal device based on indication from a network device.

In an implementation, the early synchronization process is autonomously triggered by the terminal device.

In an implementation, the early synchronization process is triggered based on a measurement result of the terminal device, and the measurement result is determined based on a measurement event and/or a pre-configured threshold.

The terminal devices 1100 and 1200 in embodiments of this application can implement corresponding functions of the terminal device in the foregoing method embodiments. For procedures, functions, implementations, and beneficial effects corresponding to each module (sub-module, unit, component, or the like) in the terminal devices 1100 and 1200, one may refer to the corresponding description in the foregoing method embodiments. Details are not described herein again. It should be noted that the described functions of various modules (sub-modules, units, components, or the like) in the terminal devices 1100 and 1200 in embodiments of this application may be implemented by different modules (sub-modules, units, components, or the like) or by a same module (sub-module, unit or component, or the like).

FIG. 13 is a schematic block diagram of a network device according to an embodiment of this application. The network device 1300 may include: a first transmitting unit 1301, configured to transmit first information, where the first information is used to determine a transmitting power corresponding to an early synchronization process of a terminal device.

In an implementation, the first information includes power control information, and the power control information is used to determine a transmitting power at which the terminal device transmits a message 1, a message A, or a preamble in a first random access process.

In an implementation, the power control information includes a power value, or the power control information includes at least one of an offset value or a ramping value that is used to adjust the transmitting power.

In an implementation, the first information includes new transmission/retransmission indication information, and the new transmission/retransmission indication information is used to indicate a new transmission or a retransmission.

In an implementation, the new transmission/retransmission indication information is used to indicate a quantity of retransmissions.

In an implementation, the first transmitting unit is further configured to transmit downlink control information, where the downlink control information is used to trigger the early synchronization process and/or one or more first random access processes.

In an implementation, the downlink control information is used to indicate at least one of the following: a candidate cell index, power control information, new transmission/retransmission indication information, random access resource indication information, BWP indication information, or a TRP index.

In an implementation, the random access resource indication information includes at least one of the following: a random access preamble index, uplink indication, supplementary uplink indication, an SSB index, or a physical random access channel mask index.

In an implementation, the downlink control information includes a physical downlink control channel PDCCH order, and the PDCCH order is used to instruct the terminal device to initiate the early synchronization process to one or more candidate cells.

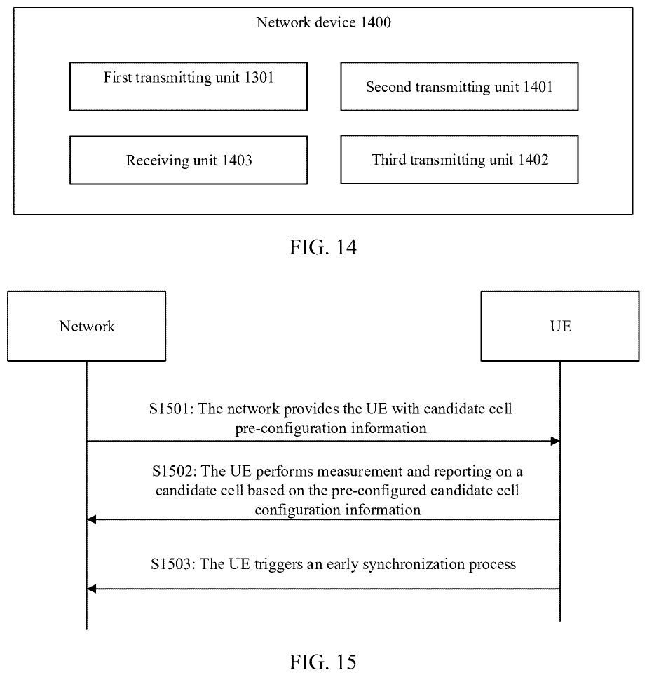

FIG. 14 is a schematic block diagram of a network device according to another embodiment of this application. The network device 1400 may include one or more features of the network device in the foregoing embodiments. In an implementation, the network device 1400 further includes: a second transmitting unit 1401, configured to transmit a cell handover command, where the cell handover command indicates a target cell to which a terminal device is to be handed over.

In an implementation, as shown in FIG. 14, the network device 1400 further includes: a third transmitting unit 1402, configured to transmit candidate cell pre-configuration information, where the candidate cell pre-configuration information includes at least one of the following:
a configuration of at least one candidate cell;
a resource and/or a configuration for performing uplink synchronization to the at least one candidate cell;
a measurement configuration and/or reporting configuration of the at least one candidate cell;
an L1 measurement configuration and/or an L3 measurement configuration; or
an L1 measurement reporting configuration and/or an L3 measurement reporting configuration.

In an implementation, the network device 1400 further includes: a receiving unit 1403, configured to receive reporting of measurement performed by the terminal device on the candidate cell based on the candidate cell pre-configuration information, where the measurement includes L1 measurement and/or L3 measurement, and the reporting of the measurement is carried in an RRC message or UCI or a MAC CE.

The network devices 1300 and 1400 in embodiments of this application can implement corresponding functions of the network device in the foregoing method embodiments. For procedures, functions, implementations, and beneficial effects corresponding to each module (sub-module, unit, component, or the like) in the network devices 1300 and 1400, one may refer to the corresponding description in the foregoing method embodiments. Details are not described herein again. It should be noted that the described functions of various modules (sub-modules, units, components, or the like) in the network devices 1300 and 1400 in embodiments of this application may be implemented by different modules (sub-modules, units, components, or the like) or by a same module (sub-module, unit or component, or the like).

Example 1: A UE maintains an independent counter/variable; and a network triggers a process by using a PDCCH order. As shown in FIG. 15, the example may include one or more of the following steps S1501 to S1503.

S1501: The network provides the UE with candidate cell pre-configuration information. The candidate cell pre-configuration information may include at least one of the following content:
a configuration of at least one candidate cell;
a resource and/or a configuration used by the UE for performing uplink synchronization to the at least one candidate cell;
a measurement and/or reporting configuration of the at least one candidate cell;
an L1 measurement configuration and/or an L3 measurement configuration; or
an L1 measurement reporting configuration and/or an L3 measurement reporting configuration.

S1502: The UE performs measurement and reporting on a candidate cell based on the pre-configured candidate cell configuration information, where the measurement may be L1 measurement and/or L3 measurement, and the reporting of the measurement may be implemented by using an RRC message or UCI or a MAC CE.

S1503: The UE triggers an early synchronization (early sync) process. The early synchronization may be autonomously triggered by the UE or triggered by a network side.

For example, the network side may determine whether to trigger an early synchronization process. Optionally, the network triggers, based on reporting of measurement of candidate cells by the UE, the UE to initiate the early synchronization process to at least one of the candidate cells.

For another example, the UE receives a PDCCH order transmitted by the network, where the PDCCH order is used to instruct the UE to initiate the early synchronization process to the at least one candidate cell. Optionally, if the network instructs the UE to initiate the early synchronization process to a plurality of candidate cells, the network may trigger the process by using one piece of signalling, for example, by carrying a plurality of candidate cell identities in indication signalling, or by transmitting a plurality of pieces of signalling. The PDCCH order may carry at least one of the following content:
a candidate cell index;
power control information, used for determining a transmitting power at which the UE transmits a message 1 (msg1), a message A (msgA), or a preamble, where the power control information may explicitly indicate a power magnitude, or may indicate at least one of an offset value (offset) or a ramping value (ramping) that is used to adjust a last power;
new transmission/retransmission indication information, which may be used to indicate a new transmission or a retransmission, and may optionally further indicate a quantity of retransmissions; or
random access resource indication information, for example, a random access preamble index, an UL/SUL indicator, an SSB index, a PRACH mask index, a BWP indicator, or a TRP index.

The UE may trigger an uplink synchronization process/a random access process based on indication of the network.

Scenario I: If the PDCCH order indicates an initial transmission/a new transmission of early synchronization (early sync) initiated to a candidate cell, for example, a first transmission of msg1/msgA, the UE performs a random access initialization procedure, performs transmission of msg1/msgA based on a pre-configured power (for example, a preamble received target power, a message A preamble received target power (msgA-Preamble Received Target Power), or the like), and sets a preamble power ramping counter for LTM (PREAMBLE_POWER_RAMPING_COUNTER_LTM) to 1. The counter may be a preamble power ramping counter (PREAMBLE_POWER_RAMPING_COUNTER) in a related random access procedure, or may be an independent counter used for LTM early synchronization.

After this transmission, the UE considers that the random access process is completed. If power ramping reuses the PREAMBLE_POWER_RAMPING_COUNTER in the related random access procedure, for a random access procedure triggered by early synchronization, the UE does not reset the counter after completing this transmission.

Scenario II: If a new random access process is triggered, the UE is required to initialize the counter when initializing new random access. Before the new random access process is triggered, and if the UE receives indication for retransmitting msg1/A or indication for power ramping, the UE increases the PREAMBLE_POWER_RAMPING_COUNTER by 1, and retransmits msg1/msgA.

In an implementation, the UE may store a value of the counter before initialization into a temporary power counter, or assign the value of the counter before initialization to a new variable, for example, a temporary preamble power ramping counter PREAMBLE_POWER_RAMPING_COUNTER_TEMPORARY. A condition for the UE to perform the foregoing storage operation may include:
indication from the network;
the newly triggered random access process occurring after a random access process used for early synchronization (for ease of description, this process may be referred to as a first random access process); or
the newly triggered random access process occurring within a first duration after the first random access process is completed. For example, the UE starts a first timer after completing the first random access process. If the first timer is in a running state when the new random access process is triggered, the UE performs the foregoing operation. In addition, a stopping condition for the first timer includes: a new random access process being triggered.

Optionally, the UE starts a second timer after performing the foregoing storage operation. If a PDCCH order for early synchronization is received during running of the second timer, and a candidate index (candidate index) included in the PDCCH order is the same as a candidate cell index corresponding to a first random process, and when a RACH process is initialized, a value of PREAMBLE_POWER_RAMPING_COUNTER may be set to a value corresponding to the temporary power counter, or a value corresponding to the variable PREAMBLE_POWER_RAMPING_COUNTER_TEMPORARY. Otherwise, the value stored in the temporary power counter is deleted, or the variable PREAMBLE_POWER_RAMPING_COUNTER_TEMPORARY is set to 1.

Optionally, after setting a value of the preamble power ramping counter (PREAMBLE_POWER_RAMPING_COUNTER) to a value corresponding to the temporary power counter (temporary power counter) or a value corresponding to a variable (for example, PREAMBLE_POWER_RAMPING_COUNTER_TEMPORARY), the UE may delete the value stored in the temporary power counter, or set the variable, for example, PREAMBLE_POWER_RAMPING_COUNTER_TEMPORARY, to 1.

Scenario III: If a power ramping counter is an independent LTM early synchronization counter, for example, PREAMBLE_POWER_RAMPING_COUNTER_LTM, the UE maintains an independent PREAMBLE_POWER_RAMPING_COUNTER_LTM for each candidate cell or each early synchronization procedure. After a first transmission/random access process is completed, the UE continues to maintain the counter. If the UE receives indication for retransmitting msg1/msgA or indication for power ramping, the UE increases the PREAMBLE_POWER_RAMPING_COUNTER_LTM by 1, and retransmits msg1/msgA. If the UE again receives, after a new transmission or a retransmission, indication information indicating that the UE initiates a new transmission of msg1/msgA to the candidate cell, the UE may skip increasing the counter by 1, and determine a target power based on a currently stored value of the counter.

S1504: If the UE receives an LTM cell handover command that instructs the UE to hand over to the target cell, the UE resets the counter. All counters of other candidate cells may be reset or retained. If the network updates the candidate cell or releases the candidate cell, a counter associated with the candidate cell also requires resetting.

In embodiments of this application, the UE may determine and/or transmit a transmit power of msg1/msgA/preamble based on the following parameters:
preamble received target power: an initial random access preamble power for a 4-step random access (RA) type (preamble Received Target Power: initial Random Access Preamble power for 4-step RA type);
msgA-preamble received target power: an initial random access preamble power for a 2-step RA type (msgA-Preamble Received Target Power: initial Random Access Preamble power for 2-step RA type);
power ramping step: a power ramping factor (power Ramping Step: the power-ramping factor); and
msgA-preamble power ramping step: a power ramping factor for an msgA-preamble (msgA-PreamblePowerRampingStep: the power ramping factor for MSGA preamble).

Example 2: A UE maintains an independent counter/variable; and the UE autonomously triggers a process.

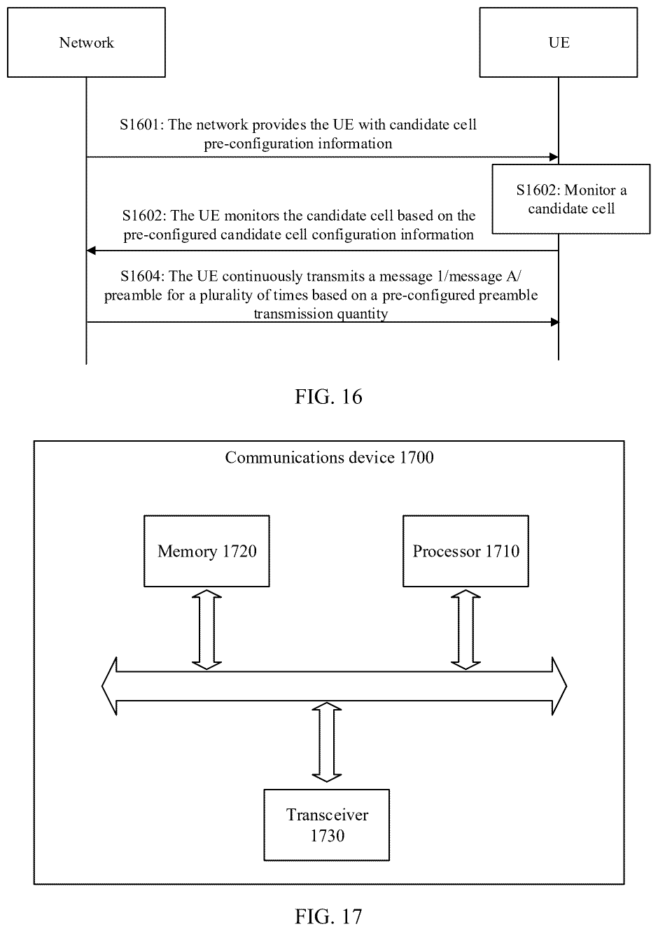

As shown in FIG. 16, the example may include one or more of the following steps S1601 to S1604.

S1601: The network provides the UE with candidate cell pre-configuration information. The candidate cell pre-configuration information includes at least one of the following content:
a configuration of at least one candidate cell;
a resource and/or a configuration used by the UE for performing uplink synchronization to the at least one candidate cell;
a measurement and/or reporting configuration of the at least one candidate cell; L1 measurement /L3 measurement and/or a reporting configuration;
an L1 measurement configuration and/or an L3 measurement configuration; or an L1 measurement reporting configuration and/or an L3 measurement reporting configuration.

S1602: The UE monitors a candidate cell based on the pre-configured candidate cell configuration information, where the candidate cell may be monitored based on the L1 measurement and/or L3 measurement.

S1603: The UE triggers an early synchronization (early sync) process, where the early synchronization may be autonomously triggered by the UE. The UE performs the early synchronization process on at least one candidate cell based on a measurement result. Specifically, the early synchronization process may be triggered based on a measurement event, or whether to trigger the early synchronization procedure may be determined based on a pre-configured threshold.

S1604: The UE continuously transmits a message 1/message A/preamble (msg1/msgA/preamble) for a plurality of times based on a pre-configured preamble transmission quantity, where each time the message 1/message A/preamble is transmitted, a power ramps once. For example, the UE increases PREAMBLE_POWER_RAMPING_COUNTER_LTM by 1, and performs a subsequent retransmission of msg1/msgA.

In embodiments of this application, a power control problem during a preamble retransmission in an early synchronization process of LTM can be resolved. In an early synchronization scenario provided in embodiments of this application, a UE maintains power ramping in a subsequent preamble transmission.

FIG. 17 is a schematic structural diagram of a communications device 1700 according to an embodiment of this application. The communications device 1700 includes a processor 1710. The processor 1710 may invoke a computer program from a memory and run the computer program, to cause the communications device 1700 to implement the method in embodiments of this application.

In an implementation, the communications device 1700 may further include a memory 1720. The processor 1710 may invoke a computer program from the memory 1720 and run the computer program, to cause the communications device 1700 to implement the method in embodiments of this application.

The memory 1720 may be an independent component separate from the processor 1710, or may be integrated into the processor 1710.

In an implementation, the communications device 1700 may further include a transceiver 1730. The processor 1710 may control the transceiver 1730 to communicate with another device. Specifically, the processor 1710 may transmit information or data to the another device, or receive information or data transmitted by the another device.

The transceiver 1730 may include a transmitter and a receiver. The transceiver 1730 may further include an antenna, and there may be one or more antennas.

In an implementation, the communications device 1700 may be the network device in embodiments of this application, and the communications device 1700 may implement corresponding procedures implemented by the network device in various methods in embodiments of this application. For brevity, details are not described herein again.

In an implementation, the communications device 1700 may be the terminal device in embodiments of this application, and the communications device 1700 may implement corresponding procedures implemented by the terminal device in various methods in embodiments of this application. For brevity, details are not described herein again.

FIG. 18 is a schematic structural diagram of a chip 1800 according to an embodiment of this application. The chip 1800 includes a processor 1810. The processor 1810 may invoke a computer program from a memory and run the computer program, to implement the method in embodiments of this application.

In an implementation, the chip 1800 may further include a memory 1820. The processor 1810 may invoke a computer program from the memory 1820 and run the computer program, to implement the method performed by the terminal device or the network device in embodiments of this application.

The memory 1820 may be an independent component separate from the processor 1810, or may be integrated into the processor 1810.

In an implementation, the chip 1800 may further include an input interface 1830. The processor 1810 may control the input interface 1830 to communicate with another device or chip, and specifically, may obtain information or data transmitted by the another device or chip.

In an implementation, the chip 1800 may further include an output interface 1840. The processor 1810 may control the output interface 1840 to communicate with another device or chip, and specifically, may output information or data to the another device or chip.

In an implementation, the chip may be applied to the network device in embodiments of this application, and the chip may implement corresponding procedures implemented by the network device in various methods in embodiments of this application. For brevity, details are not described herein again.

In an implementation, the chip may be applied to the terminal device in embodiments of this application, and the chip may implement corresponding procedures implemented by the terminal device in various methods in embodiments of this application. For brevity, details are not described herein again.

The chips used in the network device and the terminal device may be a same chip or different chips.

It should be understood that the chip mentioned in embodiments of this application may also be referred to as a system-level chip, a system chip, a chip system, a system-on-chip, or the like.

The processor mentioned above may be a general-purpose processor, a digital signal processor (DSP), a field programmable gate array (FPGA), an application specific integrated circuit (ASIC) or another programmable logic device, a transistor logic device, a discrete hardware component, or the like. The general-purpose processor mentioned above may be a microprocessor, or may be any conventional processor or the like.

The memory mentioned above may be a volatile memory or a non-volatile memory, or may include both a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM).

It should be understood that, by way of example rather than limitative description, for example, the memory in embodiments of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct Rambus random access memory (Direct Rambus RAM, DR RAM), or the like. In other words, the memory in embodiments of this application includes but is not limited to these memories and any other proper types of memories.

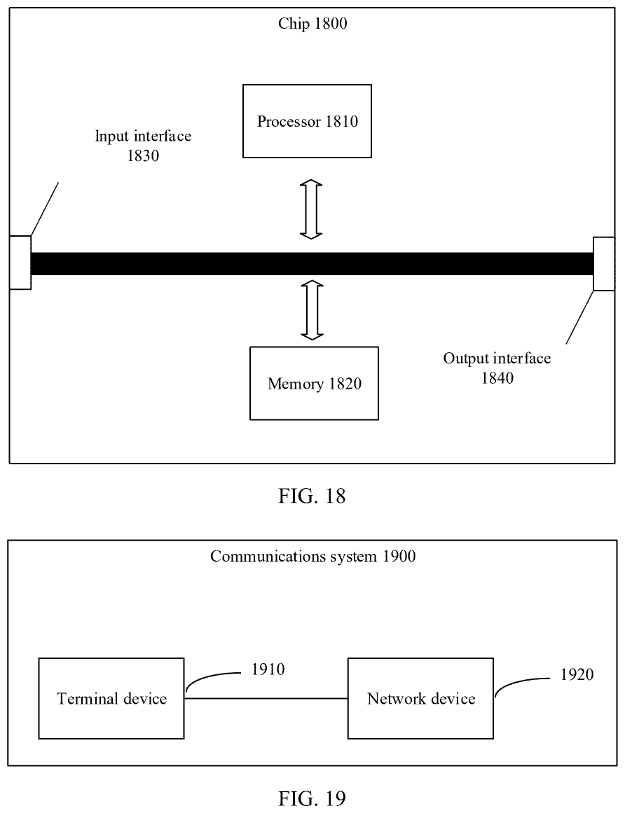

FIG. 19 is a schematic block diagram of a communications system 1900 according to an embodiment of this application. The communications system 1900 includes a terminal device 1910 and a network device 1920. The terminal device 1910 is configured to initiate an early synchronization process, where a transmitting power corresponding to the early synchronization process is determined based on first information. The network device 1920 is configured to transmit the first information, where the first information is used to determine the transmitting power corresponding to the early synchronization process of the terminal device. The terminal device 1910 may be configured to implement corresponding functions implemented by the terminal device described in the foregoing method, and the network device 1920 may be configured to implement corresponding functions implemented by the network device described in the foregoing method. For brevity, details are not described herein again.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any usable medium accessible by the computer or a data storage device, such as a server or a data center that integrates one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

It should be understood that, in embodiments of this application, sequence numbers of the foregoing processes do not mean execution sequences. The execution sequences of the processes should be determined based on functions and internal logic of the processes, and should not be construed as any limitation on the implementation processes of embodiments of this application.

It may be clearly understood by a person skilled in the art that, for convenient and brief description, for a detailed working process of the foregoing system, apparatus, and unit, reference may be made to corresponding processes in the foregoing method embodiments, and details are not described herein again.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A terminal device, comprising a memory and a processor, wherein the memory is configured to store a computer program, and the processor is configured to execute the computer program stored in the memory to cause the terminal device to perform an operation of:
initiating an early synchronization process, wherein a transmitting power corresponding to the early synchronization process is determined based on first information.

2. The terminal device according to claim 1, wherein the initiating the early synchronization process comprises:
initiating one or more first random access processes to one or more candidate cells,
wherein a transmitting power of second information in the one or more first random access processes is determined based on the first information.

3. The terminal device according to claim 2, wherein the second information comprises a message 1, a message A, or a preamble in the first random access process.

4. The terminal device according to claim 1, wherein the first information comprises a power ramp quantity in the early synchronization process.

5. The terminal device according to claim 1, wherein the first information comprises a value of a first counter, and the value of the counter is used to indicate a power ramp quantity in the early synchronization process.

6. The terminal device according to claim 5, wherein the first counter is a counter reused by early synchronization and random access, or a counter dedicated to early synchronization.

7. The terminal device according to claim 6, wherein the first counter is a preamble power ramping counter, or a preamble power ramping counter for layer 1 or layer 2 triggered mobility LTM.

8. The terminal device according to claim 5, wherein the terminal device is further configured to:
when the first counter is a counter dedicated to early synchronization, skipping resetting the first counter in a case that a second random access process is triggered for a cell the same as a cell to be accessed by using a first random access process, or resetting the first counter in a case that a second random access process is triggered for a cell different from a cell to be accessed by using a first random access process.

9. The terminal device according to claim 5, wherein the terminal device is further configured to:
when the first counter is a counter reused by early synchronization and random access, resetting the first counter when triggering a second random access process.

10. A communication method, comprising:
initiating, by a terminal device, an early synchronization process, wherein a transmitting power corresponding to the early synchronization process is determined based on first information.

11. The method according to claim 10, wherein the initiating, by the terminal device, the early synchronization process comprises:
initiating, by the terminal device, one or more first random access processes to one or more candidate cells,
wherein a transmitting power of second information in the one or more first random access processes is determined based on the first information.

12. The method according to claim 11, wherein the second information comprises a message 1, a message A, or a preamble in the first random access process.

13. The method according to claim 10, wherein the first information comprises a power ramp quantity in the early synchronization process.

14. The method according to claim 10, wherein the first information comprises a value of a first counter, and the value of the counter is used to indicate a power ramp quantity in the early synchronization process.

15. The method according to claim 14, wherein the first counter is a counter reused by early synchronization and random access, or a counter dedicated to early synchronization.

16. The method according to claim 14, wherein the first counter is a preamble power ramping counter, or a preamble power ramping counter for layer 1 or layer 2 triggered mobility LTM.

17. The method according to claim 14, wherein the method further comprises:
when the first counter is a counter dedicated to early synchronization, skipping resetting, by the terminal device, the first counter in a case that a second random access process is triggered for a cell the same as a cell to be accessed by using a first random access process, or resetting, by the terminal device, the first counter in a case that a second random access process is triggered for a cell different from a cell to be accessed by using a first random access process; and/or when the first counter is a counter reused by early synchronization and random access, resetting, by the terminal device, the first counter when triggering a second random access process.

18. A network device, comprising a memory and a processor, wherein the memory is configured to store a computer program, and the processor is configured to execute the computer program stored in the memory to cause the network device to perform an operation of:
transmitting first information, wherein the first information is used to determine a transmitting power corresponding to an early synchronization process of a terminal device.

19. The network device according to claim 18, wherein the first information comprises power control information, and the power control information is used to determine a transmitting power at which the terminal device transmits a message 1, a message A, or a preamble in a first random access process.

20. The network device according to claim 18, wherein the network device is further configured to transmit downlink control information, wherein the downlink control information is used to trigger the early synchronization process and/or one or more first random access processes.
